(19) United States
(12) Patent Application Publication
(10) Pub. No.: US 2026/0001589 A1
(43) Pub. Date: Jan. 1, 2026

(54) INFORMATION PROCESSING METHOD, RECORDING MEDIUM, AND INFORMATION PROCESSING DEVICE

(71) Applicant: Panasonic Holdings Corporation, Osaka (JP)

(72) Inventors: Motoshi ANABUKI, Hyogo (JP); Yoshimasa HONDA, Hyogo (JP)

(21) Appl. No.: 19/321,626

(22) Filed: Sep. 8, 2025

Related U.S. Application Data
(63) Continuation of application No. PCT/JP2023/046799, filed on Dec. 26, 2023.
(60) Provisional application No. 63/452,513, filed on Mar. 16, 2023.

(51) Int. Cl. B62D 15/02; B60K 35/22

(52) U.S. Cl. CPC B62D 15/02; B60K 35/22

(57) ABSTRACT

An information processing method according to one aspect of the present disclosure includes: obtaining a rotated amount of a steering wheel that controls a movement of a mobile object; and based on the rotated amount obtained, controlling a display device to display a steering wheel image representing a rotated state of the steering wheel in a display mode in accordance with a total number of rotations made by the steering wheel.

### CROSS REFERENCE TO RELATED APPLICATIONS

This is a continuation application of PCT International Application No. PCT/JP2023/046799 filed on Dec. 26, 2023, designating the United States of America, which is based on and claims priority of U.S. Provisional Patent Application No. 63/452,513 filed on Mar. 16, 2023. The entire disclosures of the above-identified applications, including the specifications, drawings and claims are incorporated herein by reference in their entirety.

### FIELD

The present disclosure relates to an information processing method, a recording medium, and an information processing device.

### BACKGROUND

From a safety standpoint, devices that present an operated amount of a steering wheel on a user interface (UI) have been conventionally available. Patent Literature (PTL) 1 discloses a display device for vehicles that displays, on a display arranged in an instrument panel or dashboard, an operated amount of an operation part that adjusts and controls a predetermined device. In this display device for vehicles, the operation part includes a rotation operation part that rotates by a manual operation performed by an operator. Moreover, the display generates and displays a display image that rotates in accordance with an operation performed to rotate the rotation operation part and indicates an amount of the operation.

### CITATION LIST

### Patent Literature

PTL 1: Japanese Unexamined Patent Application Publication No. H9-292265

### SUMMARY

### Technical Problem

The present disclosure provides an information processing method and the like that allow rotated states of a steering wheel to be readily understood.

### Solution to Problem

An information processing method according to one aspect of the present disclosure includes: obtaining a rotated amount of a steering wheel that controls a movement of a mobile object; and based on the rotated amount obtained, controlling a display device to display a steering wheel image in a display mode in accordance with a total number of rotations made by the steering wheel, the steering wheel image representing a rotated state of the steering wheel.

Note that these comprehensive or specific aspects of the present disclosure may be realized by a system, a method, an integrated circuit, a computer program, or a recording medium such as a computer-readable CD-ROM, or by an optional combination of the system, the method, the integrated circuit, the computer program, and the recording medium.

### Advantageous Effects

The information processing method and the like according to one aspect of the present disclosure allow rotated states of a steering wheel to be readily understood.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a configuration of a terminal according to an embodiment.

FIG. 2 is a diagram illustrating a display image to be displayed on an output device according to the embodiment.

FIG. 3 is a flowchart illustrating a processing procedure carried out by a management device according to example 1.

FIG. 4 is a diagram illustrating steering wheel icons according to example 1.

FIG. 5 is a flowchart illustrating a processing procedure carried out by the management device according to example 2.

FIG. 6 is a diagram illustrating steering wheel icons according to example 2.

FIG. 7 is a diagram illustrating a steering wheel icon according to example 3.

FIG. 8 is a flowchart illustrating a processing procedure carried out by the management device according to example 4.

FIG. 9 is a flowchart illustrating a processing procedure carried out by the management device according to example 5.

FIG. 10 is a diagram illustrating steering wheel icons according to example 5.

FIG. 11 is a flowchart illustrating a processing procedure carried out by the management device according to example 6.

FIG. 12 is a diagram illustrating a steering wheel icon according to example 6.

FIG. 13 is a flowchart illustrating a processing procedure carried out by the management device according to example 7.

FIG. 14 is a diagram illustrating steering wheel icons according to example 7.

FIG. 15 is a flowchart illustrating a processing procedure carried out by the management device according to example 8.

FIG. 16 is a diagram illustrating steering wheel icons according to example 8.

FIG. 17 is a flowchart illustrating a processing procedure carried out by the management device according to example 9.

FIG. 18 is a diagram illustrating a steering wheel icon according to example 9.

FIG. 19 is a flowchart illustrating a processing procedure carried out by the management device according to example 10.

FIG. 20 is a flowchart illustrating a processing procedure carried out by the management device according to example 11.

FIG. 21 is a diagram illustrated to explain a calculation method of calculating a predicted path.

FIG. 22 is a diagram illustrating a display image to be displayed on the output device according to example 11.

FIG. 23 is a flowchart illustrating a processing procedure carried out by the management device according to example 12.

FIG. 24 is a diagram illustrating a display image to be displayed on the output device according to example 12.

FIG. 25 is a flowchart illustrating an information processing method according to the embodiment.

### DESCRIPTION OF EMBODIMENTS

An information processing method according to aspect 1 of the present disclosure includes: obtaining a rotated amount of a steering wheel that controls a movement of a mobile object; and based on the rotated amount obtained, controlling a display device to display a steering wheel image representing a rotated state of the steering wheel in a display mode in accordance with a total number of rotations made by the steering wheel, the steering wheel image.

According to the above, a user can easily grasp the number of rotations made by a steering wheel just by viewing a steering wheel image. Therefore, the information processing method according to aspect 1 of the present disclosure allows rotated states of the steering wheel to be readily understood.

Moreover, for example, in the information processing method according to aspect 2 of the present disclosure, the display device is controlled to display the steering wheel image in a display mode in accordance with a direction in which the steering wheel is rotated, in the controlling according to aspect 1.

With this, whether the steering wheel is rotated rightward or leftward can be readily understood.

In addition, for example, in the information processing method according to aspect 3 of the present disclosure, the display device is controlled to display the steering wheel image in different display modes when the steering wheel is rotated and when the steering wheel is not rotated, in the controlling according to aspect 1 or 2.

With this, whether the steering wheel is rotated or not can be readily understood.

Furthermore, for example, in the information processing method according to aspect 4 of the present disclosure, the steering wheel is an operation device operated by an operator and connected to an information processing device that communicates with the mobile object, and the display device is controlled to display the steering wheel image in different display modes (i) when the operation device and the information processing device are not connected or when the information processing device and the mobile object are incapable of communicating with each other and (ii) when the operation device and the information processing device are connected and the information processing device and the mobile object are capable of communicating with each other, in the controlling according to any one of aspects 1 through 3.

When an operation device and an information processing device are not connected or when the information processing device and a mobile object are incapable of communicating with each other, the mobile object is thought to be not appropriately controlled by an operation performed on the operation device (steering wheel) by an operator. Accordingly, with the above-described information processing method, whether a mobile object is appropriately operated by an operation performed on the operation device by an operator can be readily understood.

Moreover, for example, in the information processing method according to aspect 5 of the present disclosure, the display device is controlled to display the steering wheel image that includes a numeric value indicating the rotated amount, in the controlling according to any one of aspects 1 through 4.

With this, a rotated amount of the steering wheel can be readily understood.

In addition, for example, in the information processing method according to aspect 6 of the present disclosure, the display device is controlled to display the steering wheel image in different display modes when the rotated amount is a limit value and when the rotated amount is not the limit value, in the controlling according to any one of aspects 1 through 5.

As for rightward rotations and leftward rotations of the steering wheel, there is a limit up to which the steering wheel can be operated to rotate. In view of the above, the display device is controlled to display a steering wheel image such that the steering wheel image is displayed in different display modes when a rotated amount of the steering wheel indicates a limit value and when the rotated amount of the steering wheel does not indicate the limit value. This makes it easy to understand that an operation to rotate the steering wheel is near the limit.

Furthermore, for example, in the information processing method according to aspect 7 of the present disclosure, the display device is controlled to display the steering wheel image including a steering angle image representing a steering angle of the mobile object, in the controlling according to any one of aspects 1 through 6.

With this, a steering angle of the mobile object can be readily understood.

Moreover, for example, the information processing method according to aspect 8 of the present disclosure further includes estimating a travel route of the mobile object based on a steering angle of the mobile object. In the information processing method according to aspect 8 of the present disclosure, the display device is further controlled to display a predicted path image representing the travel route estimated, in the controlling according to any one of aspects 1 through 7.

With this, how the mobile object is moved can be readily understood.

In addition, for example, a program according to aspect 9 of the present disclosure causes a computer to execute the information processing method according to any one of aspects 1 to 8.

According to the above, advantageous effects the same as the advantageous effects produced by the information processing method according to any one of aspects 1 through 8 of the present disclosure are produced.

Furthermore, for example, an information processing device according to aspect 10 of the present disclosure includes: an obtainer that obtains a rotated amount of a steering wheel that controls a movement of a mobile object; and a controller that controls, based on the rotated amount obtained, a display device to display a steering wheel image in a display mode in accordance with a total number of rotations made by the steering wheel, the steering wheel image representing a rotated state of the steering wheel.

According to the above, advantageous effects the same as the advantageous effects produced by the information processing method according to aspect 1 of the present disclosure are produced.

Hereinafter, embodiments will be described in detail with reference to the drawings.

Note that the embodiments below each describe a general or specific example. The numeric values, shapes, materials, elements, the arrangement and the connection of the elements, steps, orders of the steps etc. illustrated in the following embodiments are mere examples, and are not intended to limit the present disclosure.

In addition, the drawings are schematic diagrams, and do not necessarily provide strictly accurate illustrations. Accordingly, the drawings do not necessarily coincide with one another in terms of scales and the like, for example. Throughout the drawings, the same reference sign is given to substantially the same element or the process, and redundant description may be omitted or simplified.

In the present specification, when, for example, “greater than a threshold” is stated in contrast with “less than or equal to (or at most) the threshold”, this contrast means a distinction made using the threshold as the boundary, and the foregoing phrases may mean “greater than or equal to (or at least) the threshold” and “less than the threshold”.

Moreover, in the present specification, ordinal numbers such as “first”, “second”, and so on do not mean the number of elements or the order of the elements unless otherwise stated. The purposes of using ordinal numbers are to avoid confusion with one another and to distinguish between elements of the same type.

### Embodiment

### Configuration

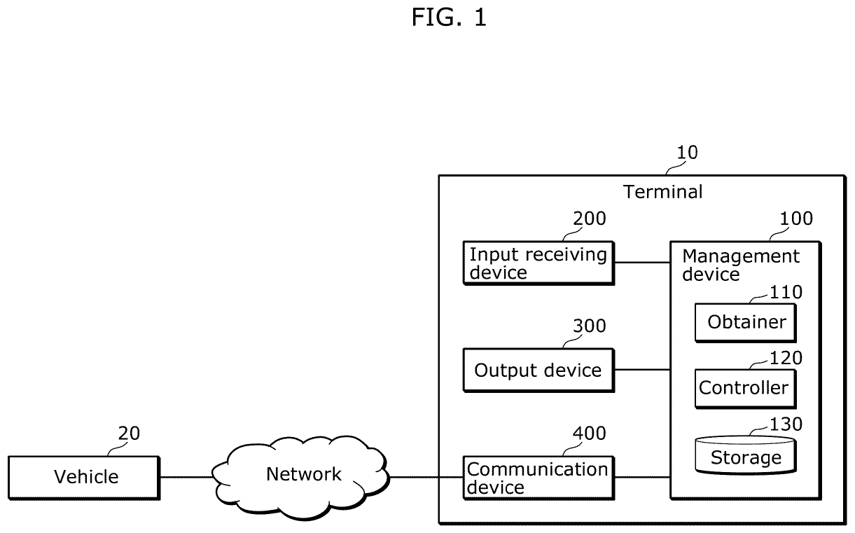

FIG. 1 is a block diagram illustrating a configuration of terminal 10 according to an embodiment.

Terminal 10 is a device for outputting information about vehicle 20.

Vehicle 20 is, for example, an automobile. In the present embodiment, vehicle 20 is a vehicle that can be remotely controlled by terminal 10. More specifically, vehicle 20 is remotely monitored by an operator (user) via a remote control system. In some cases, vehicle 20 can be moved by a remote operation performed by the operator via the remote control system.

Note that vehicle 20 may be a manual operation type vehicle that can be manually driven by a driver in the vehicle or may be an autonomous mobile type vehicle.

Here, the remote control system is operated in a remote control center in which one or more operators are present or by a server device. The remote control system is a system for each operator to remotely monitor, or in some cases, remotely operate one or more vehicles 20. Each operator monitors, using terminal 10 such as a personal computer or the like, condition of each vehicle 20 which is to be output to (e.g., to be displayed on) output device 300. Moreover, for example, when a remote operation is requested from vehicle 20 or when it is determined that vehicle 20 is in a state to be remotely operated, each operator remotely operates vehicle 20.

Vehicle 20 includes, for example, a wireless communication interface for communicating with terminal 10 via a network such as the Internet, a positioning system such as a global positioning system (GPS) that detects positions of vehicle 20, various types of sensors such as a speed sensor, an acceleration sensor, an angular speed sensor, a ranging sensor, a camera, light detection and ranging (LIDAR), and radar, and a processing unit that is the main controller of vehicle 20. The wireless communication interface is realized by, for example, a wireless communication circuit, etc. The processing unit is realized by, for example, a processor such as a central processing unit (CPU) and memory that stores control programs to be executed by the processor. The memory is, for example, read-only memory (ROM) and random-access memory (RAM), and can store programs to be executed by the processor.

Terminal 10 is a terminal, such as a smartphone, a tablet terminal, or a personal computer. Terminal 10 is hereinafter described as a personal computer. Although FIG. 1 illustrates one terminal 10, a plurality of terminals 10 are present when a plurality of operators are present, and each of the plurality of terminals 10 are used by each operator.

Terminal 10 includes management device 100, input receiving device 200, output device 300, and communication device 400.

Management device 100 is a computer that performs various types of processes. Management device 100 is linked with each of input receiving device 200, output device 300, and communication device 400 to manage and control the whole terminal 10. Management device 100 is realized by, for example, memory, a processor that executes programs stored in the memory, and a storage device that stores various types of information. The memory is ROM and RAM, and can store programs to be executed by the processor. Management device 100 is one example of the information processing device.

Management device 100 includes obtainer 110, controller 120, and storage 130.

Obtainer 110 is a processing unit that obtains various types of information. Obtainer 110 obtains, for example, information that an operator inputs into input receiving device 200, information about vehicle 20 from vehicle 20 via communication device 400, and information stored in storage 130. For example, obtainer 110 obtains an operated amount (specifically, operation information indicating the operated amount) of a steering wheel that controls movements of vehicle 20. For example, the steering wheel that control movements of vehicle 20 is input receiving device 200. Obtainer 110 obtains, from input receiving device 200, an operated amount input into (an amount of operation performed on) input receiving device 200 by an operator, for example. Note that obtainer 110 may obtain, from vehicle 20, an operated amount of the steering wheel provided in vehicle 20. In other words, obtainer 110 may obtain an operated amount from input receiving device 200, or may obtain an operated amount resulting from an actual operation performed by vehicle 20 based on the operated amount obtained from input receiving device 200.

Controller 120 is a processing unit that performs various types of processes. Controller 120 controls information to be output by output device 300 and transmits information to vehicle 20 via communication device 400, for example. In the present embodiment, output device 300 is a display that displays images. Controller 120 controls images to be displayed on output device 300. For example, based on an obtained operated amount, controller 120 controls output device 300 to display a steering wheel image representing a rotated state of the steering wheel such that the steering wheel image is displayed in a display mode in accordance with the number of rotations made by the steering wheel.

Each of the processing units, such as obtainer 110 and controller 120, is realized by, for example, a processor and memory that stores control programs to be executed by the processor.

Storage 130 is a storage device that stores various types of information. Storage 130 stores information such as vehicle type information and a conversion table, for example. These foregoing information items will be described later in the embodiment. Storage 130 is realized by, for example, a hard disk drive (HDD) or a solid-state drive (SSD).

Input receiving device 200 is an input receiving interface that receives inputs from an operator. Input receiving device 200 may include, for example, the steering wheel for controlling movements of vehicle 20. Moreover, input receiving device 200 may include, for example, elements for controlling movements of vehicle 20, such as the accelerator pedal and brake pedal. In addition, input receiving device 200 may include, for example, a pointing device such as a keyboard and a mouse. Input receiving device 200 receives, for example, inputs of driving operations to be performed on vehicle 20 by an operator.

Output device 300 outputs information processed by management device 100. Output device 300 is one example of a display device. Output device 300 is realized by, for example, a display such as a liquid crystal display.

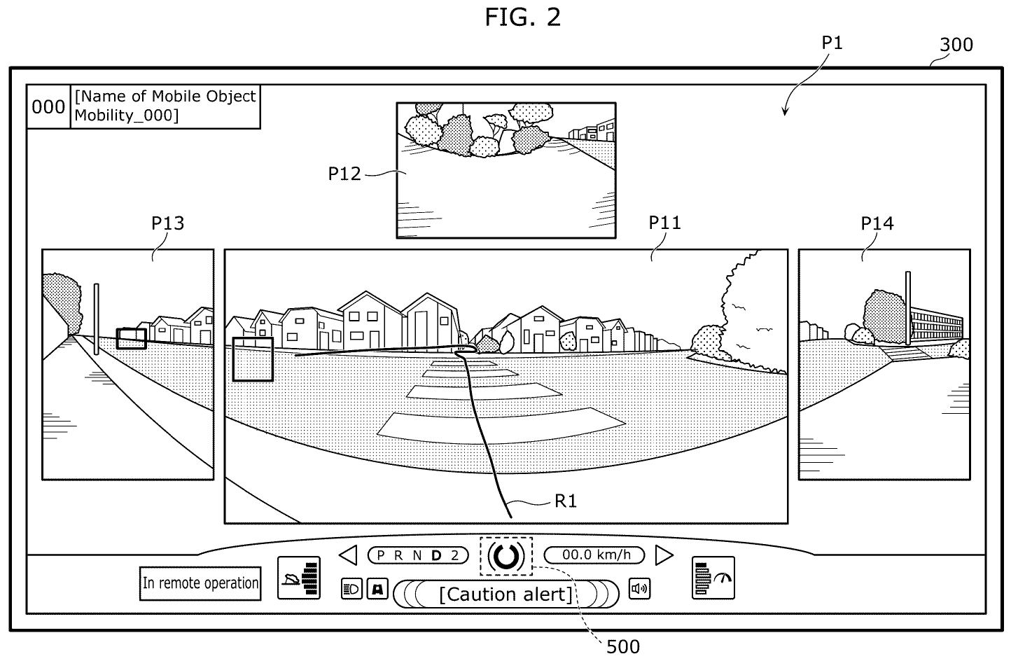

FIG. 2 is a diagram illustrating display image P1 to be displayed on output device 300 according to the embodiment.

Output device 300 displays, for example, a video such as display image P1 transmitted from management device 100. More specifically, output device 300 displays a video (image P11) capturing a front view of vehicle 20, a video (image P13) capturing a left side view of vehicle 20, a video (image P14) capturing a right side view of vehicle 20, a video (image P12) capturing a rear view of vehicle 20, etc. In addition, output device 300 displays, based on information transmitted from management device 100, information such as the speed and angular speed of vehicle 20, states of a system provided in vehicle 20, and route R1 that vehicle 20 intends to travel (e.g., a route from the current location of vehicle 20 to a destination), for example.

Output device 300 also displays a steering wheel image.

The steering wheel image is an image (icon) that represents a rotated state of the steering wheel provided in vehicle 20. Obtainer 110 obtains, from input receiving device 200, an operated amount of the steering wheel (specifically, a rotated amount of the steering wheel indicating an amount of, for example, a rotated angle of the steering wheel when the steering wheel is operated to rotate). Based on the rotated amount obtained by obtainer 110, controller 120 controls output device 300 to display a steering wheel image representing the rotated state of the steering wheel such that the steering wheel image is displayed in a display mode in accordance with the number of rotations made by the steering wheel. Steering wheel icon 500 shown in FIG. 2 is one example of the steering wheel image.

Note that output device 300 may include, besides the display, devices that output information using sound, such as an amplifier and a loudspeaker.

Communication device 400 is a wireless communication interface for communicating with vehicle 20 via a network. The wireless communication interface is realized by, for example, a wireless communication circuit, etc. Communication device 400 receives information about vehicle 20 which is transmitted from vehicle 20.

When input receiving device 200 receives, from an operator, an input for operating the steering wheel (e.g., an input indicating an operated amount of the steering wheel) of vehicle 20, management device 100 transmits, to vehicle 20, a signal corresponding to the input for operating the steering wheel (e.g., information indicating the operated amount) via communication device 400. Moreover, management device 100 controls output device 300 to display a steering wheel image corresponding to the operated amount. Vehicle 20 operates the steering wheel, etc., provided in vehicle 20 in accordance with the received signal.

Note that vehicle 20 may transmit, to management device 100, operation information indicating an operated amount resulting from an actual operation performed on the steering wheel provided in vehicle 20. When management device 100 receives the operation information, management device 100 may control output device 300 to display the steering wheel image corresponding to the operated amount indicated by the operation information.

### Operation

Operations performed by management device 100 according to the embodiment will be hereinafter described.

### Example 1

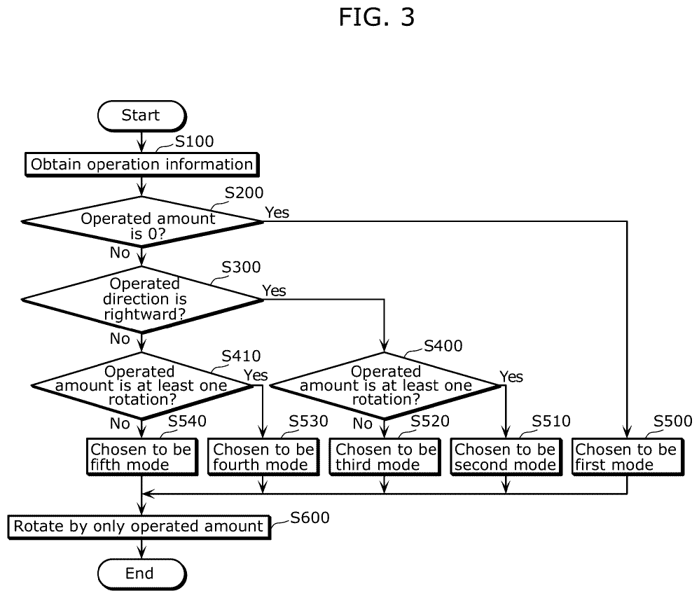

FIG. 3 is a flowchart illustrating a processing procedure carried out by management device 100 according to example 1.

First, obtainer 110 obtains operation information containing an operated amount of a steering wheel (S100). For example, obtainer 110 obtains the operation information indicating an operated amount resulting from an actual operation performed on the steering wheel which is associated with the time at which the steering wheel was actually operated.

Next, controller 120 determines whether the operated amount indicated by the operation information obtained by obtainer 110 is zero (S200). In other words, controller 120 determines whether the steering wheel is in a state of not being operated (stated differently, in a non-rotated state).

When controller 120 determines that the operated amount is zero (Yes in S200), controller 120 chooses a display mode of the steering wheel image to be the first mode (S500).

Alternatively, when controller 120 determines that the operated amount is not zero (No in S200), controller 120 determines whether the operated direction of the steering wheel (i.e., the rotated direction in which the steering wheel is rotated) is rightward (S300).

When controller 120 determines that the operated direction of the steering wheel is rightward (Yes in S300), controller 120 determines whether the operated amount is at least one rotation (i.e., one complete turn or more) (S400). In other words, controller 120 determines whether the steering wheel is in a state of being operated to make at least one rotation to the right. For example, when the operated amount is indicated by a rotated angle where the direction of rightward rotation is taken as the positive direction, controller 120 determines whether the operated amount is 360 degrees or more.

When controller 120 determines that the operated amount is at least one rotation (Yes in S400), controller 120 chooses a display mode of the steering wheel image to be the second mode (S510).

Alternatively, when controller 120 determines that the operated amount is not at least one rotation (No in S400), controller 120 chooses a display mode of the steering wheel image to be the third mode (S520).

When controller 120 determines that the operated direction of the steering wheel is not rightward (No in S300), or stated differently, when controller 120 determines that the operated direction of the steering wheel is leftward, controller 120 determines whether the operated amount is at least one rotation (S410). In other words, controller 120 determines whether the steering wheel is in a state of being operated to make at least one rotation to the left. For example, when the operated amount is indicated by a rotated angle where the direction of rightward rotation is taken as the positive direction, controller 120 determines whether the operated amount is −360 degrees or less.

When controller 120 determines that the operated amount is at least one rotation (Yes in S410), controller 120 chooses a display mode of the steering wheel image to be the fourth mode (S530).

Alternatively, when controller 120 determines that the operated amount is not at least one rotation (No in S410), controller 120 chooses a display mode of the steering wheel image to be the fifth mode (S540).

Controller 120 rotates the steering wheel image in the display mode chosen in steps S500 through S540 by only the operated amount (i.e., by only an angle corresponding to the operated amount) (S600). Controller 120 controls output device 300 to display the rotated steering wheel image. For example, controller 120 controls the steering wheel image to be superimposed on display image P1 displayed on output device 300 to be displayed. Moreover, when controller 120 has already controlled output device 300 to display the steering wheel image, controller 120 changes a display mode of the steering wheel to the chosen display mode, and controls the steering wheel image to rotate by only the operated amount.

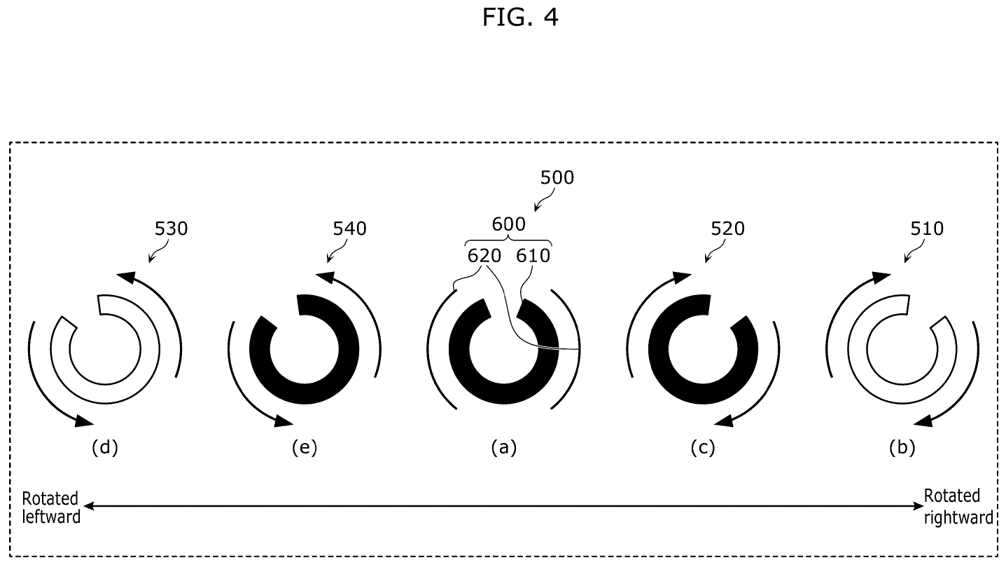

FIG. 4 is a diagram illustrating steering wheel icons 500 through 540 according to example 1. Steering wheel icons 500 through 540 are mere examples of the steering wheel image. Note that steering wheel icon 500 given (a) in FIG. 4 is one example of the steering wheel image in the first mode. Moreover, steering wheel icon 510 given (b) in FIG. 4 is one example of the steering wheel image in the second mode. In addition, steering wheel icon 520 given (c) in FIG. 4 is one example of the steering wheel image in the third mode. Furthermore, steering wheel icon 530 given (d) in FIG. 4 is one example of the steering wheel image in the fourth mode. Moreover, steering wheel icon 540 given (e) in FIG. 4 is one example of the steering wheel image in the fifth mode.

The steering wheel image includes rotation portion 600 as shown by, for example, steering wheel icon 500.

Rotation portion 600 is an image rotated in accordance with an operated amount. Rotation portion 600 consists of, for example, center portion 610 and surrounding portion 620.

Center portion 610 is an image in the shape imitating the steering wheel. For example, center portion 610 is in a circular shape whose portion is cut off (specifically, in a C shape). For example, the cut off portion of center portion 610 is to be displayed such that the cut off portion is arranged on the upper side when the steering wheel is in a state of not being operated (operated to rotate) relative to the position used as the reference for vehicle 20 to travel forward, for example. Center portion 610 is rotated in accordance with an operated amount of the steering wheel to be displayed when the steering wheel is operated, like, for example, steering wheel icons 510 through 540. Moreover, for example, steering wheel icons 500, 520, and 540 representing a state of the steering wheel not making at least one rotation are displayed with its center portions 610 filled in with black. In contrast, steering wheel icons 510 and 530 each representing a state of the steering wheel making at least one rotation are displayed with their center portions 610 filled in with white.

Surrounding portion 620 is an image representing a rotated direction of the steering wheel. For example, when the steering wheel is in a state of not being operated, surrounding portion 620 is to be displayed on output device 300 in circular arc shapes without arrows on respective sides of center portion 610. When the steering wheel is operated, surrounding portion 620 is displayed by arrows to indicate a rotated direction of the steering wheel, like, for example, steering wheel icons 510 through 540. When the steering wheel is operated to rotate in the right direction, surrounding portion 620 is displayed by arrows to indicate that the rotated direction of the steering wheel is rightward, like, for example, steering wheel icons 510 and 520. In contrast, when the steering wheel is operated to rotate in the left direction, surrounding portion 620 is displayed by arrows to indicate that the rotated direction of the steering wheel is leftward, like, for example, steering wheel icons 530 and 540.

As has been described above, when the steering wheel is in a state of making at least one rotation, the steering wheel image is displayed in a display mode different from a display mode of the steering wheel image displayed when the steering wheel is not making at least one rotation. In other words, management device 100 obtains an operated amount (specifically, operation information indicating the operated amount) of the steering wheel that controls the movement of vehicle 20, and, based on the obtained operated amount, controls output device 300 to display the steering wheel image (e.g., any one of steering wheel icons 500 through 540) representing a rotated state of the steering wheel such that the steering wheel image is displayed in a display mode in accordance with the number of rotations made by the steering wheel. For example, in the process of controlling output device 300 to display the steering wheel image, management device 100 changes the display mode of the steering wheel image when the number of rotations made by the steering wheel is changed. Moreover, for example, in the process of controlling output device 300 to display the steering wheel image, management device 100 controls output device 300 to display the steering wheel image such that the steering wheel image is displayed in different display modes (i) when the steering wheel is rotated at least a predetermined number of times and (ii) when the steering wheel is not rotated at least the predetermined number of times.

According to the above, a user can easily grasp the number of rotations made by the steering wheel just by viewing the steering wheel image. This allows an operator to readily understand rotated states of the steering wheel.

In addition, for example, when the steering wheel is rotated rightward, the steering wheel image is displayed in a display mode different from a display mode of the steering wheel image displayed when the steering wheel is rotated leftward. In other words, in the process of controlling output device 300 to display the steering wheel image, management device 100 controls output device 300 to display the steering wheel image in a display mode in accordance with the direction in which the steering wheel is rotated, for example. Specifically, in the process of controlling output device 300 to display the steering wheel image, management device 100 controls output device 300 to display the steering wheel image such that the steering wheel image is displayed in different display modes (i) when the steering wheel is rotated rightward and (ii) when the steering wheel is rotated leftward.

This allows an operator to readily understand whether the steering wheel is rotated rightward or leftward.

In addition, when the steering wheel is not operated (specifically, when the steering wheel is not rotated), the steering wheel image is displayed in a display mode different from a display mode of the steering wheel image displayed when the steering wheel is operated, for example. In other words, in the process of controlling output device 300 to display the steering wheel image, management device 100 controls output device 300 to display the steering wheel image such that the steering wheel image is displayed in different display modes (i) when the steering wheel is operated and (ii) when the steering wheel is not operated, for example.

This allows an operator to readily understand whether the steering wheel is rotated.

Note that the above-described example has presented color differences and the presence and absence of arrows as examples of different display modes, but the steering wheel display modes to be chosen are not limited to the foregoing. The display modes of the steering wheel image may be chosen by an optional combination of display modes, such as colors, hatching, sizes, luminance, shapes, and/or symbols.

In addition, the above-described predetermined number of times may be one time, two times, three times or more. The above-described predetermined number of times is not particularly limited. Moreover, the steering wheel image may be controlled to be displayed on output device 300 such that the steering wheel image is displayed in different display modes (i) when the steering wheel is making one rotation and (ii) when the steering wheel is making two rotations.

### Example 2

Next, example 2 will be described. In example 2, management device 100 further determines, in addition to the process described in example 1, whether the steering wheel is controlled to make at least two rotations (i.e., two complete turns or more).

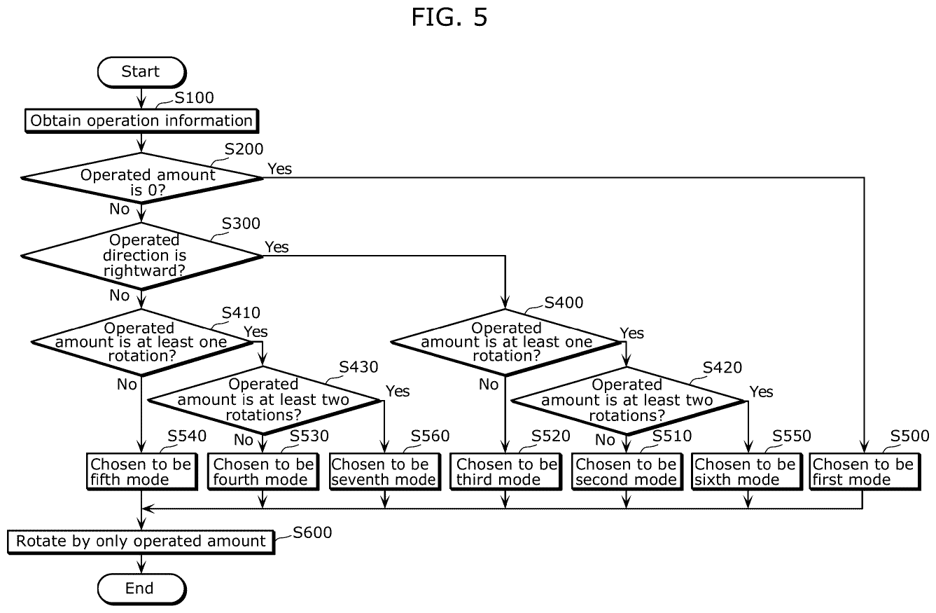

FIG. 5 is a flowchart illustrating a processing procedure carried out by management device 100 according to example 2.

In example 2, when controller 120 determines that the operated direction of the steering wheel is rightward (Yes in S300) and the operated amount is at least one rotation (Yes in S400), controller 120 further determines whether the operated amount is at least two rotations (S420).

When controller 120 determines that the operated amount is at least two rotations (Yes in S420), controller 120 chooses a display mode of the steering wheel image to be the sixth mode (S550).

Alternatively, when controller 120 determines that the operated amount is not at least two rotations (No in S420), or stated differently, when the operated amount is at least one rotation and less than two rotations (i.e., one complete turn or more but less than two complete turns), controller 120 chooses a display mode of the steering wheel image to be the second mode (S510).

Moreover, in example 2, when the operated direction of the steering wheel is leftward (No in S300) and the operated amount is at least one rotation (Yes in S410), controller 120 further determines whether the operated amount is at least two rotations (S430).

When controller 120 determines that the operated amount is at least two rotations (Yes in S430), controller 120 chooses a display mode of the steering wheel image to be the seventh mode (S560).

Alternatively, when controller 120 determines that the operated amount is not at least two rotations (No in S430), or stated differently, when the operated amount is at least one rotation and less than two rotations, controller 120 chooses a display mode of the steering wheel image to be the fourth mode (S530).

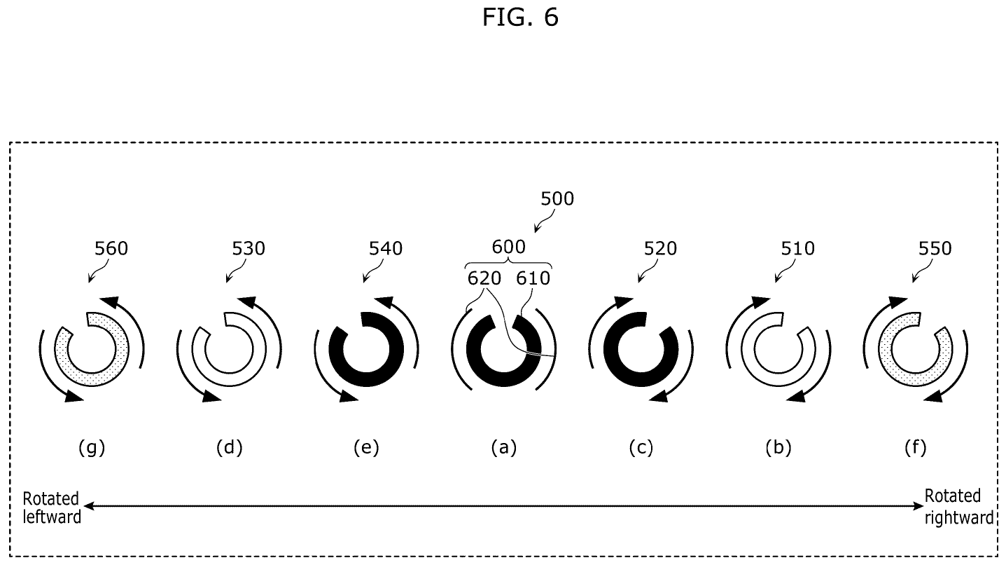

FIG. 6 is a diagram illustrating steering wheel icons 500 through 560 according to example 2. Steering wheel icons 500 through 560 are mere examples of the steering wheel image. Note that steering wheel icons 500 through 540 given (a) through (e) in FIG. 6 are, like steering wheel icons 500 through 540 given (a) through (e) in FIG. 4, mere examples of the steering wheel image in the first mode through the fifth mode. In addition, steering wheel icon 550 given (f) in FIG. 4 is one example of the steering wheel image in the sixth mode. Moreover, steering wheel icon 560 given (g) in FIG. 4 is one example of the steering wheel image in the seventh mode.

As shown by steering wheel icons given (f) and (g) in FIG. 6, steering wheel icons 550 and 560 each representing a state of the steering wheel making at least two rotations are displayed with their center portions 610 marked with hatching.

As described above, in example 2, when the steering wheel is in a state of making at least two rotations, the steering wheel image is displayed in a display mode different from a display mode of the steering wheel image displayed when the steering wheel is not making at least two rotations. As described above, the steering wheel image is displayed in a display mode in accordance with each of the numbers of rotations made by the steering wheel. As a matter of course, the steering wheel image may be displayed in a display mode in accordance with each of the numbers of rotations made by the steering wheel, even if the number of rotations made by the steering wheel is three or more, such as at least three rotations (i.e., three complete turns or more).

### Example 3

Next, example 3 will be described. In example 3, the display mode of the center portion of the steering wheel image is different from the display mode of the center portion of the steering wheel image described in examples 1 and 2.

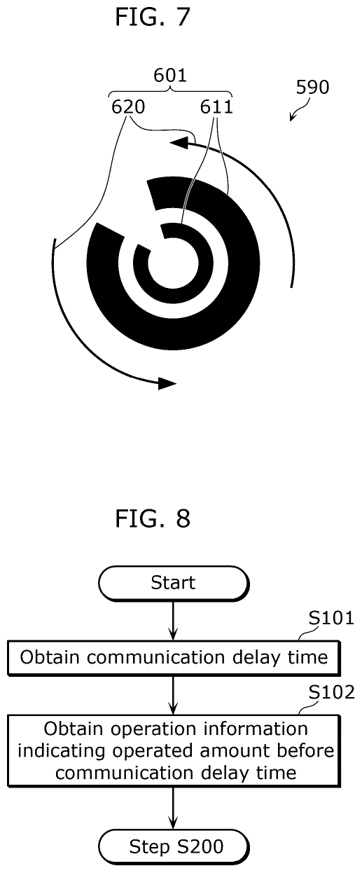

FIG. 7 is a diagram illustrating steering wheel icon 590 according to example 3. Steering wheel icon 590 is one example of the steering wheel image.

Steering wheel icon 590 is the steering wheel image representing a state of the steering wheel being controlled to make at least one rotation to the left. Steering wheel icon 590 includes rotation portion 601.

Rotation portion 601 is an image to be rotated in accordance with an operated amount. Rotation portion 601 consists of, for example, center portion 611 and surrounding portion 620.

Center portion 611 is an image in the shape imitating the steering wheel. For example, center portion 611 is in a circular shape whose portion is cut off (specifically, in a C shape). In the present example, center portion 611 includes double circular arcs (two circular arcs). As such, in the present example, the number of circular arcs of center portion 611 increases in accordance with the number of rotations made by the steering wheel. For example, controller 120 chooses a display mode of the steering wheel image such that: (i) when the number of rotations made by the steering wheel is less than one rotation, the number of circular arcs of center portion 611 is one, (ii) when the number of rotations made by the steering wheel is at least one rotation and less than two rotations, the number of circular arcs of center portion 611 is two, and (iii) when the number of rotations made by the steering wheel is at least two rotations, the number of circular arcs of center portion 611 is three.

As described, the number of arcs of center portion 611 may be changed in accordance with the number of rotations made by the steering wheel.

### Example 4

Next, example 4 will be described. In example 4, management device 100 obtains an operated amount for which a communication time between terminal 10 and vehicle 20 is taken into consideration.

FIG. 8 is a flowchart illustrating a processing procedure carried out by management device 100 according to example 4.

First, obtainer 110 obtains a communication delay time that is a delay time taken for communication between terminal 10 and vehicle 20 (S101).

The communication delay time is, for example, a time taken from when the steering wheel is operated by an operator using input receiving device 200 to when information indicating the operation that has been performed on the steering wheel using input receiving device 200 is transmitted to vehicle 20 by terminal 10 and vehicle 20 is actually controlled in accordance with the information. Information indicating a communication delay time may be prestored in storage 130, or may be measured by actual communication performed between terminal 10 and vehicle 20.

Next, obtainer 110 obtains operation information indicating an operated amount before the communication delay time (S102). For example, operation information is periodically and repeatedly transmitted to management device 100 in response to operations performed on the steering wheel by an operator. Among the operation information items that have been repeatedly transmitted, obtainer 110 obtains an operation information item of the time the communication delay time before the present time (the time at which step S102 is to be performed).

Controller 120 performs the processes from step S200 onward presented in examples 1 and 2, based on the operation information obtained in step S102.

As has been described above, management device 100 executes steps S101 and S102 instead of the above-described step S100.

For example, for vehicle 20 to be controlled and the tires of vehicle 20 to actually move, the amount of the above-described communication delay time will be delayed since the time when the steering wheel is operated. In view of the above, management device 100 takes the delay into consideration, and rotates an icon on the UI, namely the steering wheel image displayed on output device 300, for example.

This reduces a difference between a timing when the steering wheel image to be displayed on output device 300 is rotated and a timing when vehicle 20 is actually controlled by a steering wheel operation performed by an operator. Accordingly, an operator can readily perform a remote operation on vehicle 20 while the operator is viewing an image displayed on output device 300.

Note that management device 100 may include a clock unit such as a real-time clock (RTC).

### Example 5

Next, example 5 will be described. In example 5, the steering wheel image includes rotation portion 600 and stationary portion 630.

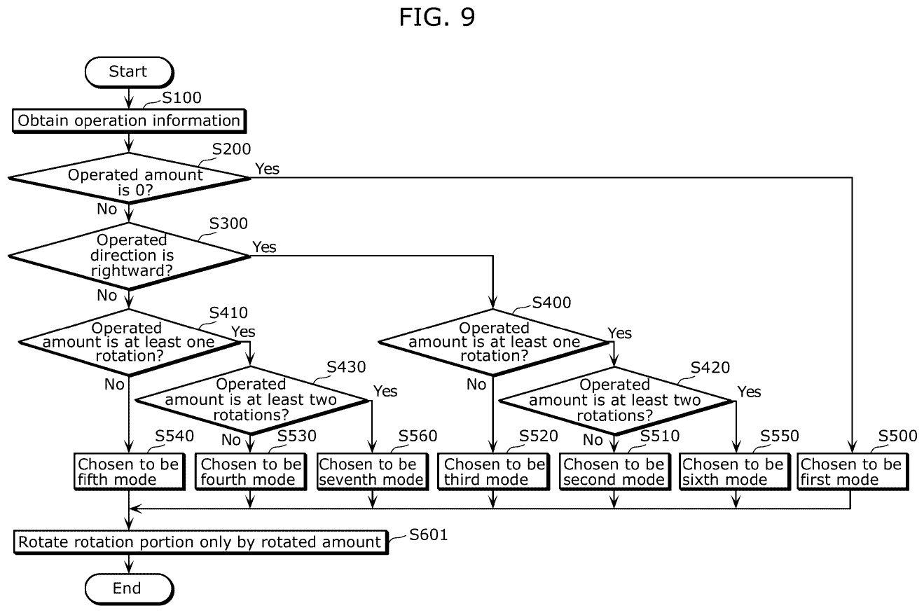

FIG. 9 is a flowchart illustrating a processing procedure carried out by management device 100 according to example 5.

Management device 100 performs processes from steps S100 through S560 in the same manner as the processes according to example 2 as illustrated in FIG. 5.

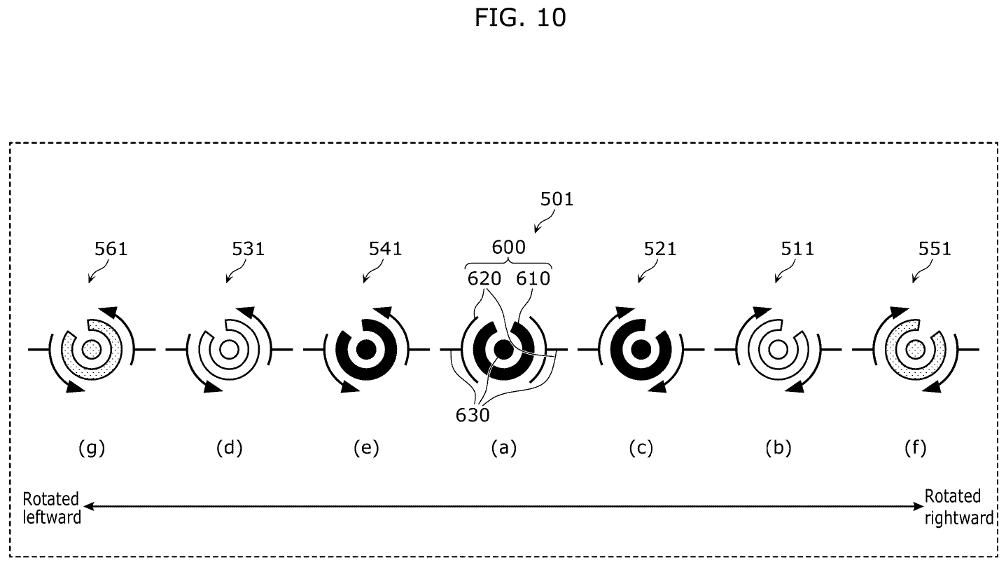

After a display mode of the steering wheel image is chosen by any one of the processes from steps S500 through S560, controller 120 rotates the rotation portion of the steering wheel image by an operated amount (S601). Specifically, out of rotation portion 600 and stationary portion 630 (see FIG. 10) included in the steering wheel image, controller 120 controls only rotation portion 600 to rotate by only an angle corresponding to the operated amount. Rotation portion 600 and stationary portion 630 will be described later in the embodiment. In other words, controller 120 does not control stationary portion 630 to rotate regardless of the operated amount.

FIG. 10 is a diagram illustrating steering wheel icons 501, 511, 521, 531, 541, 551, and 561 according to example 5.

Steering wheel icons 501, 511, 521, 531, 541, 551, and 561 are mere examples of the steering wheel image. Note that steering wheel icon 501 given (a) in FIG. 10 is one example of the steering wheel image in the first mode. Moreover, steering wheel icon 511 given (b) in FIG. 10 is one example of the steering wheel image in the second mode. In addition, steering wheel icon 521 given (c) in FIG. 10 is one example of the steering wheel image in the third mode. Furthermore, steering wheel icon 531 given (d) in FIG. 10 is one example of the steering wheel image in the fourth mode. Moreover, steering wheel icon 541 given (e) in FIG. 10 is one example of the steering wheel image in the fifth mode. In addition, steering wheel icon 551 given (f) in FIG. 10 is one example of the steering wheel image in the sixth mode. Furthermore, steering wheel icon 561 given (g) in FIG. 10 is one example of the steering wheel image in the seventh mode.

Steering wheel icons 501, 511, 521, 531, 541, 551, and 561 given (a) through (g) in FIG. 10 are variations of steering wheel icons 500, 510, 520, 530, 540, 550, and 560 given (a) through (g) in FIG. 6.

The steering wheel image according to example 5 includes rotation portion 600 and stationary portion 630, like, for example, steering wheel icon 501 given (a) in FIG. 10.

In contrast to rotation portion 600, stationary portion 630 is an image not to be rotated regardless of an operated amount. In other words, stationary portion 630 is a portion not to be rotated in the steering wheel image. By displaying stationary portion 630 together with rotation portion 600, stationary portion 630 serves as a gauge of a rotated amount of rotation portion 600. This allows an operator to readily understand to what extent rotation portion 600 is rotated.

Note that, in the same manner as rotation portion 600, a display mode of stationary portion 630 may be changed or need not be changed in accordance with the number of rotations made by the steering wheel.

### Example 6

Next, example 6 will be described. The steering wheel provided to control the movement of vehicle 20 is input receiving device 20 connected to management device 100 that communicates with vehicle 20, for example. Accordingly, vehicle 20 is operated by an operator via input receiving device 200. In example 6, management device 100 determines, when an operator performs an input into input receiving device 200 to operate the steering wheel, whether the steering wheel is appropriately operated in accordance with the input.

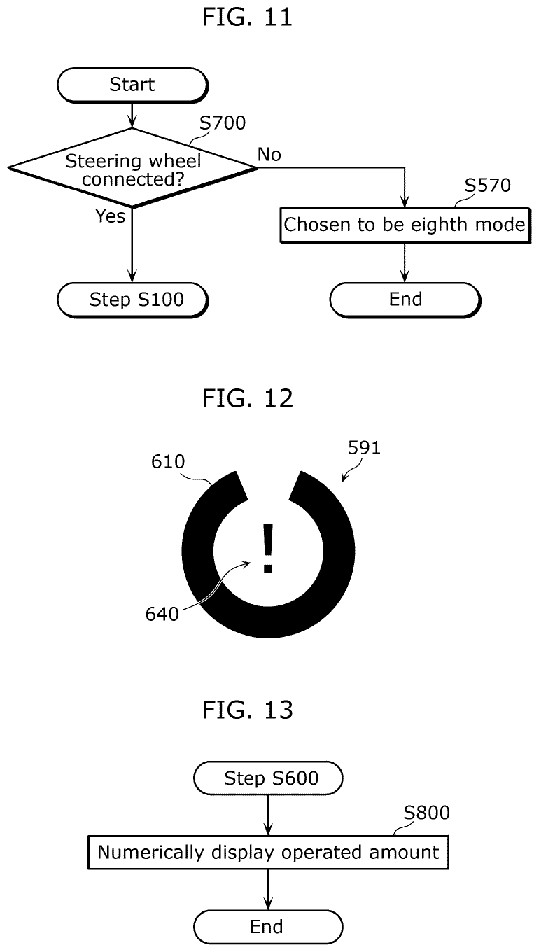

FIG. 11 is a flowchart illustrating a processing procedure carried out by management device 100 according to example 6.

First, controller 120 determines whether the steering wheel is connected (S700). Specifically, controller 120 determines whether a steering wheel operation (i.e., an input into input receiving device 200) performed by an operator is appropriately transmitted to vehicle 20. For example, controller 120 determines whether input receiving device 200 and management device 100 are communicably connected. Alternatively, controller 120 determines whether management device 100 (more specifically, communication device 400 to which management device 100 is connected) and vehicle 20 are communicable, for example.

When controller 120 determines that the steering wheel is connected (Yes in S700), the processing moves on to the above-described step S100 (or step S101). For example, when management device 100 determines that input receiving device 200 and management device 100 are communicably connected and/or when management device 100 determines management device 100 and vehicle 20 are communicable, management device 100 performs processes from the above-described step S100 (or step S101) onward.

Alternatively, when controller 120 determines that the steering wheel is not connected (No in S700), controller 120 chooses a display mode of the steering wheel image to be the eighth mode (S570). For example, when management device 100 determines that input receiving device 200 and management device 100 are not communicably connected and/or when management device 100 determines that management device 100 and vehicle 20 are not communicable, management device 100 chooses a display mode of the steering wheel image to be the eighth mode and controls output device 300 to display the steering wheel image in the chosen display mode.

FIG. 12 is a diagram illustrating steering wheel icon 591 according to example 6. Steering wheel icon 591 is one example of the steering wheel image. Specifically, steering wheel icon 591 is one example of the steering wheel image in the eighth mode.

Steering wheel icon 591 consists of center portion 610 and connection information icon 640.

Connection information icon 640 is information indicating that the steering wheel is not operated even if an operator performs an input into input receiving device 200 to operate the steering wheel.

Note that steering wheel icon 591 need not include center portion 610. Moreover, although connection information icon 640 is an exclamation mark in the present example, an optional display mode is to be adopted as long as the steering wheel image is in different display modes (i) when the steering wheel is connected and (ii) when the steering wheel is not connected.

As has been described above, the steering wheel provided to control movements of vehicle 20 is input receiving device 200 that is operated by an operator and is connected to management device 100 that communicates with vehicle 20. Moreover, in the process of controlling output device 300 to display the steering wheel image, management device 100 controls output device 300 to display the steering wheel image such that the steering wheel image is in different display modes (i) when input receiving device 200 and management device 100 are not connected or when management device 100 and vehicle 20 are incapable of communicating with each other and (ii) when input receiving device 200 and management device 100 are connected and management device 100 and vehicle 20 are capable of communicating with each other, for example.

This allows an operator to readily understand whether vehicle 20 is appropriately controlled by an operation performed on an operation device by an operator.

### Example 7

Next, example 7 will be described. In example 7, management device 100 controls output device 300 to numerically display an operated amount.

FIG. 13 is a flowchart illustrating a processing procedure carried out by management device 100 according to example 7.

For example, subsequent to the above-described step S600, controller 120 controls output device 300 to display a number indicating an operated amount (S800). Specifically, controller 120 controls output device 300 to display the steering wheel image including a numeric value that indicates the operated amount.

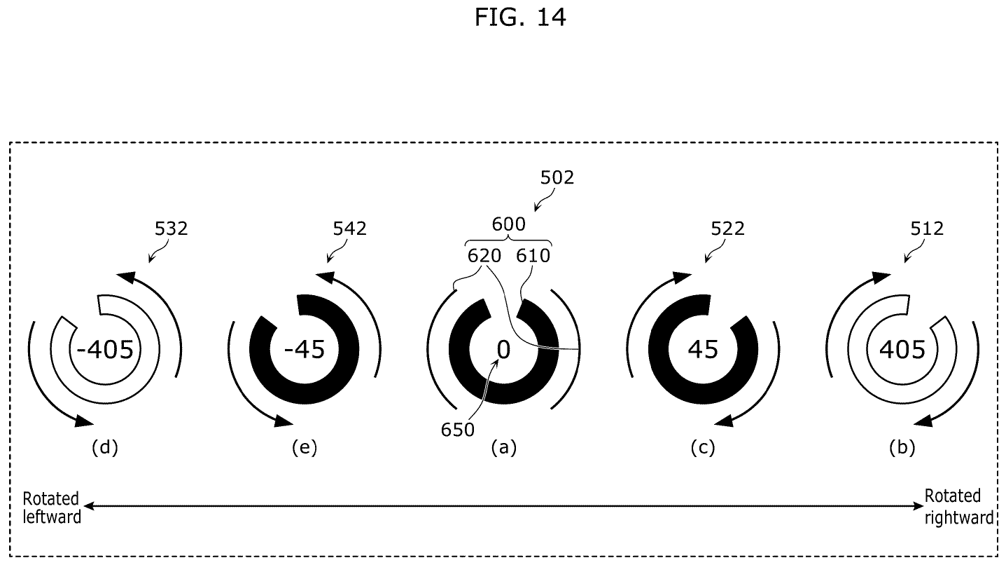

FIG. 14 is a diagram illustrating steering wheel icons 502, 512, 522, 532, and 542 according to example 7.

Steering wheel icons 502, 512, 522, 532, and 542 are mere examples of the steering wheel image. Note that steering wheel icon 502 given (a) in FIG. 14 is one example of the steering wheel image in the first mode. Moreover, steering wheel icon 512 given (b) in FIG. 14 is one example of the steering wheel image in the second mode. In addition, steering wheel icon 522 given (c) in FIG. 14 is one example of the steering wheel image in the third mode. Furthermore, steering wheel icon 532 given (d) in FIG. 14 is one example of the steering wheel image in the fourth mode. Moreover, steering wheel icon 542 given (e) in FIG. 14 is one example of the steering wheel image in the fifth mode.

Steering wheel icons 502, 512, 522, 532, and 542 given (a) through (e) in FIG. 14 are variations of steering wheel icons 500, 510, 520, 530, and 540 given (a) through (e) in FIG. 4.

The steering wheel image according to example 7 includes rotation portion 600 and numeric value portion 650, like, for example, steering wheel icon 502 given (a) in FIG. 14.

Numeric value portion 650 is a number indicating an operated amount of the steering wheel. For example, when the steering wheel is in a state of being operated to rotate 45 degrees in the right direction, numeric value portion 650 representing the operated amount of the steering wheel is displayed on output device 300 like “45” in the steering wheel icon given (c) in FIG. 14. Moreover, for example, when the steering wheel is in a state of being operated to rotate 45 degrees in the left direction, numeric value portion 650 representing the operated amount of the steering wheel is displayed on output device 300 like “−45” in the steering wheel icon given (e) in FIG. 14.

As has been described above, in the process of controlling output device 300 to display the steering wheel image, management device 100 controls output device 300 to display the steering wheel image that includes a numeric value indicating an operated amount of the steering wheel, for example.

According to the above, an operated amount of the steering wheel can be readily understood.

### Example 8

Next, example 8 will be described. In example 8, when an operated amount (rotated amount) of the steering wheel is rotated up to the limit value (maximum value), or stated differently, when the steering wheel is rotated up to the maximum number of rotations (the number of rotations up to the limit position of steering wheel rotation in the left and right directions), management device 100 controls output device 300 to display the steering wheel image in a display mode different from a display mode of the steering wheel image displayed when the steering wheel is not rotated up to the maximum number of rotations.

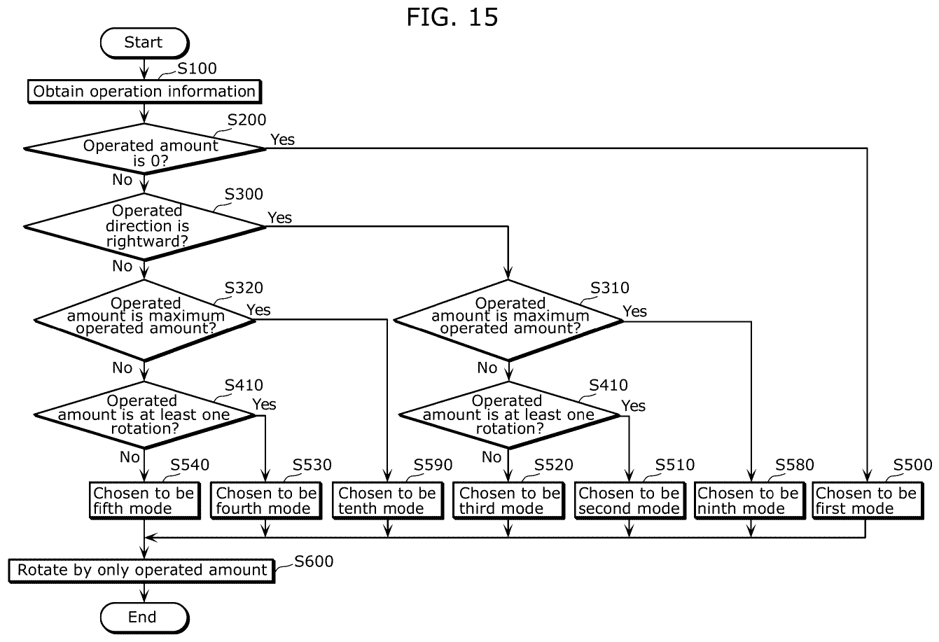

FIG. 15 is a flowchart illustrating a processing procedure carried out by management device 100 according to example 8.

In example 8, when the operated direction of the steering wheel is rightward (Yes in S300), controller 120 further determines whether an operated amount is the maximum operated amount (S310). Specifically, controller 120 determines whether the operated amount is the maximum number of rotations (limit value) to be made by the steering wheel. Information indicating the limit value is prestored in storage 130, for example. Information indicating the limit value may be obtained from an external device such as vehicle 20. The limit value may be determined by the limit value of the steering wheel actually provided in vehicle 20, for example. Moreover, the limit value may be determined by the limit value of the operated amount of the steering wheel that is included in input receiving device 200 and is operated by an operator, for example.

When controller 120 determines that the operated amount is the maximum operated amount (Yes in S310), controller 120 chooses a display mode of the steering wheel image to be the ninth mode (S580).

Alternatively, when controller 120 determines that the operated amount is not the maximum operated amount (No in S310), the processing moves on to step S400.

Moreover, in example 8, when the operated direction of the steering wheel is leftward (No in S300), controller 120 further determines whether the operated amount is the maximum operated amount (S320).

When controller 120 determines that the operated amount is the maximum operated amount (Yes in S320), controller 120 chooses a display mode of the steering wheel image to be the tenth mode (S590).

Alternatively, when controller 120 determines that the operated amount is not the maximum operated amount (No in S320), the processing moves on to step S410.

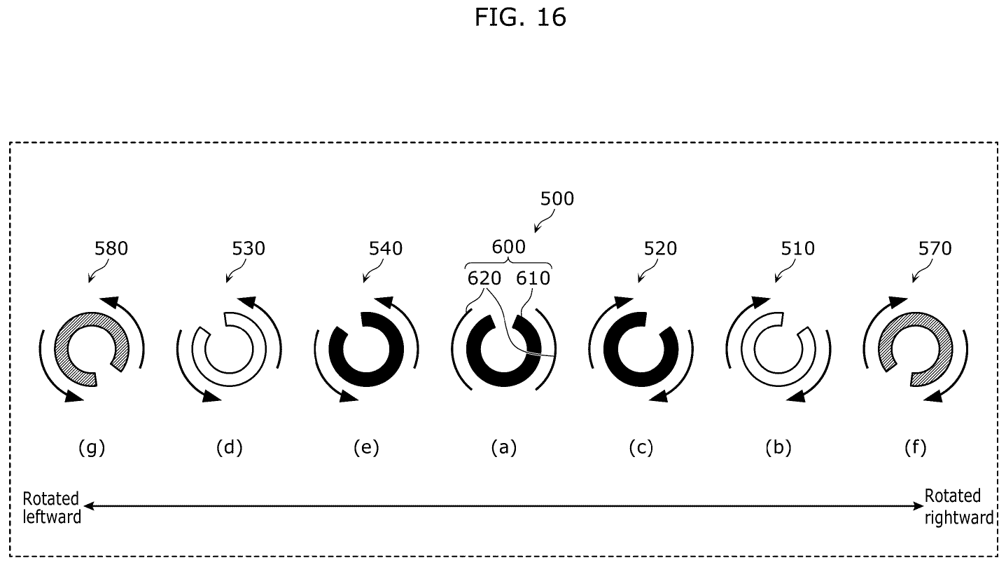

FIG. 16 is a diagram illustrating steering wheel icons 500, 510, 520, 530, 540, 570, and 580 according to example 8. Steering wheel icon 500, 510, 520, 530, 540, 570, and 580 are mere examples of the steering wheel image. Note that steering wheel icons 500 through 540 given (a) through (e) in FIG. 16 are mere examples of the steering wheel image in the first mode through the fifth mode, like steering wheel icons 500 through 540 given (a) through (e) in FIG. 4. Moreover, steering wheel icon 570 given (f) in FIG. 16 is one example of the steering wheel image in the ninth mode. In addition, steering wheel icon 580 given (g) in FIG. 16 is one example of the steering wheel image in the tenth mode.

As illustrated in the steering wheel icons given (f) and (g) in FIG. 16, steering wheel icons 570 and 580 each representing a state of the steering wheel being rotated up to the maximum number of rotations are displayed with their center portions 610 marked with hatching. For example, steering wheel icons 570 and 580 are displayed marked with hatching different from hatching of steering wheel icons 550 and 560.

As has been described above, in the process of controlling output device 300 to display the steering wheel image, management device 100 controls output device 300 to display the steering wheel image such that the steering wheel image is displayed in different display modes (i) when the number of rotations made by the steering wheel is a limit value and (ii) when the number of rotations made by the steering wheel is not the limit value.

When vehicle 20 is operated (controlled) by a remote operation performed by an operator, a limit value of the rotated amount up to which the steering wheel can be operated to rotate may differ between input receiving device 200 used by an operator and the steering wheel actually provided in vehicle 20. In this case, an operator has, among other difficulties, a difficulty in understanding whether the steering wheel has reached the limit over which the steering wheel cannot be operated to rotate to control vehicle 20. In view of the above, output device 300 is controlled to display the steering wheel image such that the steering wheel image is displayed in different display modes (i) when the rotated amount of the steering wheel is the limit value and (ii) when the rotated amount of the steering wheel is not the limit value. This allows the operator to readily understand that the operation to rotate the steering wheel is near the limit.

Note that when the operated amount of the steering wheel indicates the limit value, management device 100 may control output device 300 to run animations of steering wheel icons 570 and 580 in a manner that steering wheel icons 570 and 580 vibrate for a predetermine time period. For example, when management device 100 controls output device 300 to display steering wheel icons 570 and 580, management device 100 controls output device 300 to display steering wheel icons 570 and 580 in a display mode in which steering wheel icons 570 and 580 vibrate left and right and/or up and down for a predetermined time period.

Note that the predetermined time period can be optionally determined, and is not particularly limited.

### Example 9

Next, example 9 will be described. In example 9, management device 100 controls output device 300 to display an icon representing a steering angle of vehicle 20 (an orientation of a tire relative to the front side of vehicle 20).

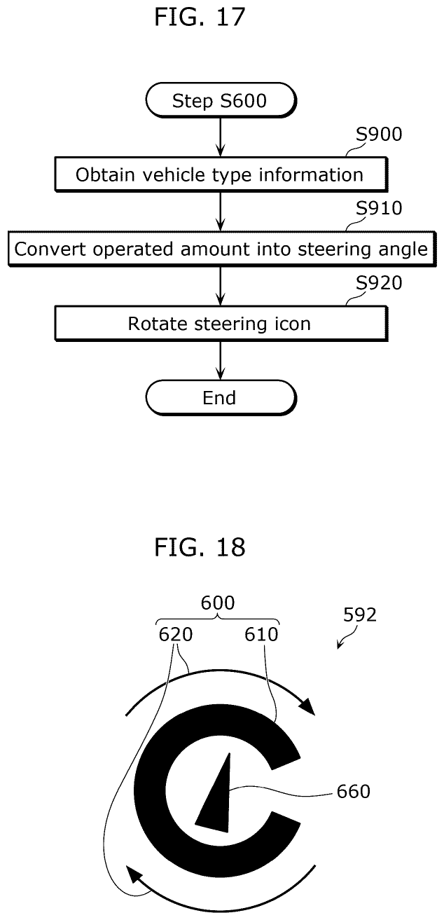

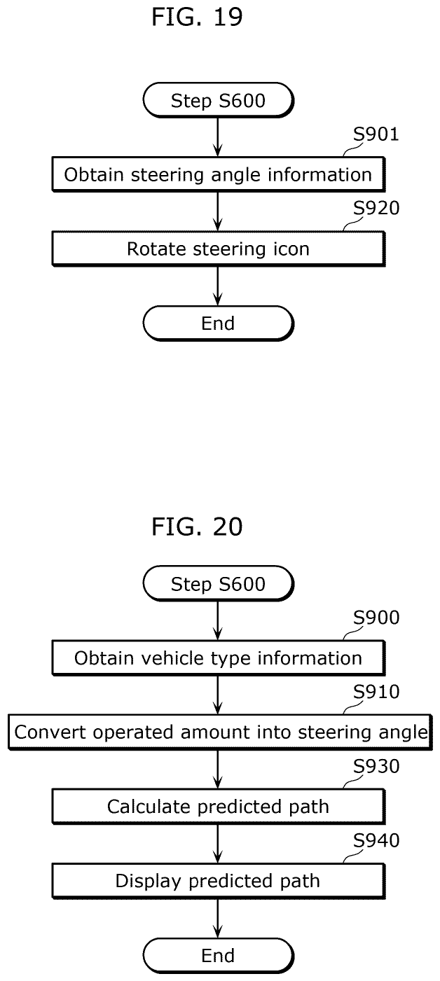

FIG. 17 is a flowchart illustrating a processing procedure carried out by management device 100 according to example 9.

Obtainer 110 obtains, for example, subsequent to step S600, vehicle type information (S900).

The vehicle type information indicates the type of vehicle 20. The vehicle type information may be obtained from vehicle 20 or may be prestored in storage 130.

Next, based on the obtained vehicle type information, controller 120 converts an obtained operated amount into a steering angle of vehicle 20 (S910). For example, a conversion table is prestored in storage 130. The conversion table includes parameters for calculating steering angles that are associated with vehicle types. For example, controller 120 uses the conversion table to convert an operated amount into a steering angle.

The conversion table includes, for example, a ratio of an operated amount of the steering wheel to a steering angle which is associated with, for example, a vehicle type. The ratio is more specifically, information indicating the expression (operated amount of the steering wheel)/(average steering angle), and is hereafter simply referred to as a conversion ratio. For example, when the vehicle type is “truck A”, the conversion table includes the following information: the conversion ratio is “2”, the width of the vehicle is “2 m”, the wheelbase length is “6 m”, etc. The conversion table includes, for a plurality of vehicle types, the above-described information corresponding to a vehicle type. For example, when the vehicle type is “robot B”, the conversion table includes the following information: the conversion ratio is “1.5”, the width of the vehicle is “0.6 m”, the wheelbase length is “1.0 m”, etc. For example, when the vehicle type is “vehicle C”, the conversion table includes the following information: the conversion ratio is “1.2”, the width of the vehicle is “1.8 m”, the wheelbase length is “5 m”, etc.

For example, when the obtained vehicle type information indicates “truck A”, or in other words, when the type of vehicle 20 is “truck A”, controller 120 calculates a steering angle using an obtained operated amount and the conversion ratio “2”.

Next, controller 120 rotates a steering angle image representing a steering angle which is included in the steering wheel image by only the calculated steering angle (i.e., only an angle corresponding to the calculated steering angle) (S920). Controller 120 controls output device 300 to display the steering wheel image that includes the rotated steering angle image and is in the chosen display mode.

Note that steps S900 through S920 may be executed prior to step S600.

FIG. 18 is a diagram illustrating steering wheel icon 592 according to example 9. Steering wheel icon 592 is one example of the steering wheel image.

Steering wheel icon 592 is a steering wheel image representing a state of the steering wheel being not controlled to rotate at least one rotation and being rotated 90 degrees to the right.

Steering wheel icon 592 consists of rotation portion 600 and steering icon 660. Steering icon 660 is one example of the steering angle image.

Steering icon 660 is an image that is rotated in accordance with a steering angle. In the present example, steering icon 660 is in the shape of an isosceles triangle whose height is greater than the base, and is displayed on output device 300 such that the vertex is pointed upward when the steering is not pivotally moved (i.e., when the steering angle is zero), for example. In the present example, steering wheel icon 592 represents a state of the steering wheel being rotated 90 degrees to the right as described above, and steering icon 660 is shown such that steering icon 660 is rotated by only an angle corresponding to a steering angle calculated from the operated amount and the conversion table.

Note that, in the same manner as rotation portion 600, the display mode of steering icon 660 may be changed or need not be changed in accordance with the number of rotations made by the steering wheel.

Moreover, steering icon 660 need not be in the shape of an isosceles triangle and may be in any optional shapes.

As has been described above, in the process of controlling output device 300 to display the steering wheel image, management device 100 controls output device 300 to display the steering wheel image that includes a steering angle image representing a steering angle of vehicle 20, for example.

This allows an operator to readily understand the steering angle of vehicle 20.

### Example 10

Next, example 10 will be described. In example 10, management device 100 controls a steering icon to rotate based on steering angle information indicating a steering angle of vehicle 20 to be displayed on output device 300.

Obtainer 110 obtains, for example, subsequent to step S600, steering angle information indicating a steering angle of vehicle 20 (S901). Obtainer 110 obtains the steering angle information from vehicle 20 via, for example, communication device 400.

Next, controller 120 rotates the steering angle image representing a steering angle and included in the steering wheel image by only the steering angle indicated by the obtained steering angle information (S920).

According to the above-described processes, a process of calculating a steering angle will not be required. Note that when the steering angle image is controlled to be displayed and rotated using the above-described processes, the above-described conversion table need not be stored in storage 130.

Note that steps S901 and S920 may be executed prior to step S600.

### Example 11

Next, example 11 will be described. In example 11, management device 100 controls output device 300 to display a predicted path of vehicle 20.

FIG. 20 is a flowchart illustrating a processing procedure carried out by management device 100 according to example 11.

Obtainer 110 obtains, for example, subsequent to step S600, vehicle type information (S900).

Next, based on the obtained vehicle type information, controller 120 converts an obtained operated amount into a steering angle of vehicle 20 (S910).

Next, controller 120 estimates, based on the calculated steering angle, a travel route of vehicle 20 (e.g., a route along which vehicle 20 will be moving in the immediate future by an operation performed by an operator) to calculate the predicted path indicating the estimated travel route (S930). Controller 120 uses, for example, the above-described conversion table to calculate the predicted path.

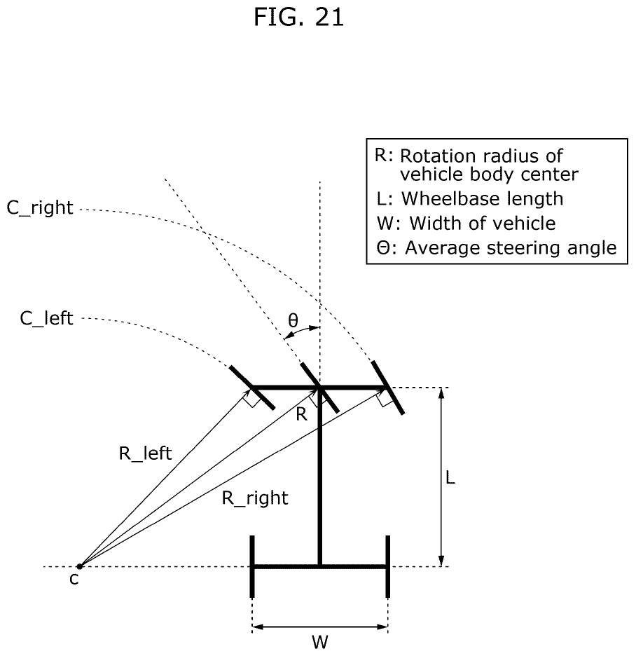

FIG. 21 is a diagram illustrated to explain a calculation method of calculating a predicted path. Specifically, FIG. 21 illustrates a vehicle model made based on vehicle 20, or stated differently, a model representing vehicle 20 in an abbreviated manner. More specifically, FIG. 21 illustrates the vehicle model of vehicle 20 in top view, and the top portion of the diagram is the forward direction of the vehicle model.

Note that the lowercase letter c denotes the rotation center of the vehicle model. Specifically, the lowercase letter c denotes the center of the path (rotation path) of a travel route of vehicle 20 when vehicle 20 travels forward giving a clockwise or counter clockwise turn. The expression C_left indicates a rotation path of the left front wheel. The expression C_right indicates a rotation path of the right front wheel. The capital letter R indicates a rotation radius of the vehicle body center (center portion of the two front wheels) of the vehicle model. The expression R_left indicates a rotation radius of the left front wheel. The expression R_right indicates a rotation radius of the right front wheel. The capital letter L indicates the wheelbase length of the vehicle model. The capital letter W indicates the width of the vehicle model. The letter of the Greek alphabet θ indicates the average steering angle (e.g., average value of steering angles of the left and right front wheels of vehicle 20).

For example, when the vehicle model turns right, the rotation radii are calculated as follows:

$$R\_left = sqrt ( ( R cos ( θ ) + W / 2 ) \hat{} 2 + L \hat{} 2 ) , and$$

$$R\_right = sqrt ( ( R cos ( θ ) - W / 2 ) \hat{} 2 + L \hat{} 2 ) .$$

Moreover, when the vehicle model turns left, the rotation radii are calculated as follows:

$$R\_left = sqrt ( ( R cos ( θ ) - W / 2 ) \hat{} 2 + L \hat{} 2 ) , and$$

$$R\_right = sqrt ( ( R cos ( θ ) + W / 2 ) \hat{} 2 + L \hat{} 2 ) .$$

The calculated R_left and R_right indicate the predicted path of vehicle 20.

Next, controller 120 converts coordinates of the calculated predicted path of vehicle 20 into coordinates in a camera image coordinate system (coordinate system used when a predicted path is controlled to be displayed on output device 300), and controls output device 300 to display the converted predicted path (S940).

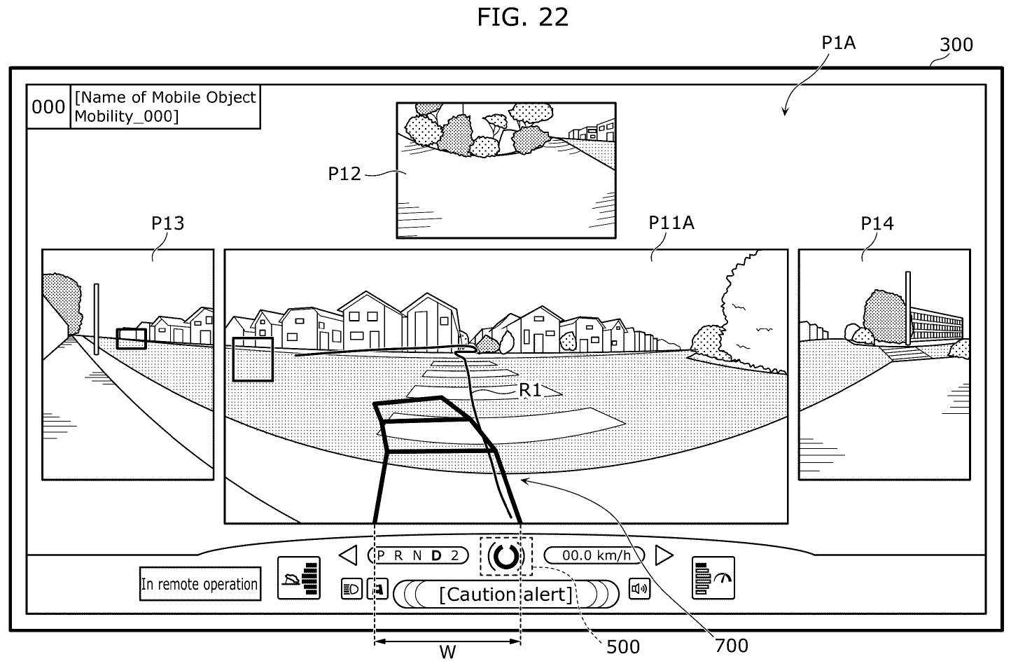

FIG. 22 is a diagram illustrating display image P1A to be displayed on output device 300 according to example 11.

Display image P1A includes, for example, a video (image P11A) capturing a front view of vehicle 20, a video (image P12) capturing a rear view of vehicle 20, a video (image P13) capturing a left side view of vehicle 20, a video (image P14) capturing a right side view of vehicle 20, the steering wheel image such as steering wheel icon 500, etc. Image P11A is an image obtained by superimposing calculated predicted path 700 on image P11 illustrated in FIG. 2 to be displayed. Predicted path 700 is one example of a predicted path image.

Controller 120 uses, for example, calculated R_left, calculated R_right, and vehicle width W to choose the size and shape of predicted path 700 to be superimposed on image P11A to be displayed, and controls output device 300 to display image P11A including the chosen predicted path 700. For example, controller 120 controls output device 300 to display predicted path 700 from vehicle 20 to a predetermined distance. The present example presents the lines 1 m, 2 m, and 3 m from the front side of vehicle 20 by horizontal lines of the latter shape representing predicted path 700. In addition, the right-side longitudinal line of predicted path 700 indicates a predicted path of the right side tire of vehicle 20, and the left-side longitudinal line of predicted path 700 indicates a predicted path of the left side tire of vehicle 20. Note that the predetermined distance can be optionally determined, and is not particularly limited.

As has been described above, management device 100 estimates a travel route of vehicle 20 based on a steering angle of vehicle 20, for example. Moreover, in the process of controlling output device 300 to display the steering wheel image, management device 100 controls output device 300 to further display a predicted path image representing an estimated travel route.

According to the above, how vehicle 20 will be moving in the immediate future can be readily understood.

Note that steps S900, S910, S920, S930, and S940 may be executed prior to step S600.

### Example 12

Next, example 12 will be described. In example 12, management device 100 controls output device 300 to display a prediction path of vehicle 20 with consideration given to a communication delay time and the speed of vehicle 20.

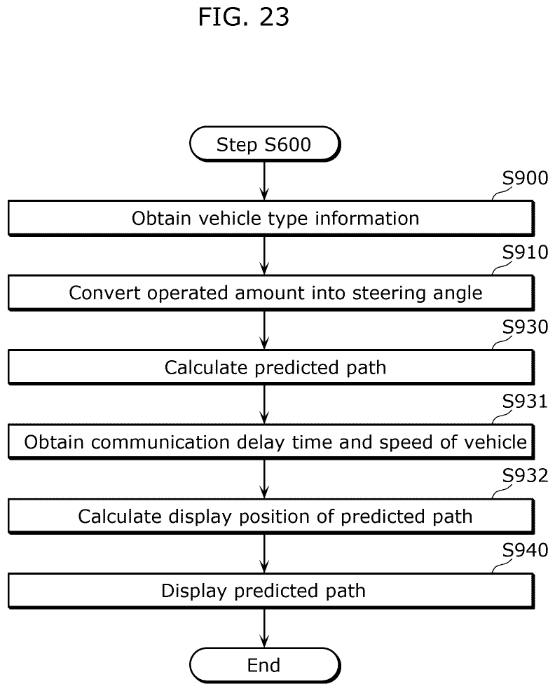

FIG. 23 is a flowchart illustrating a processing procedure carried out by management device 100 according to example 12.

Management device 100 performs, for example, subsequent to step S600, steps S900 through S930 in the same manner as the steps in the flowchart illustrated in FIG. 20.

Next, obtainer 110 obtains information indicating the above-described communication delay time and information indicating a speed of vehicle 20 (S931). For example, obtainer 110 obtains information indicating the speed of vehicle 20 from vehicle 20 via communication device 400. Obtainer 110 may obtain, from input receiving device 200, information indicating the speed of vehicle 20 which is input into input receiving device 200 by an operator.

Next, controller 120 chooses a display position of a predicted path based on the communication delay time and the speed of vehicle 20 obtained by obtainer 110 (S932).

Next, controller 120 converts coordinates of the predicted path into coordinates of the camera image coordinate system, and controls output device 300 to display the predicted path of vehicle 20 such that the converted predicted path is displayed in the chosen display position (S940).

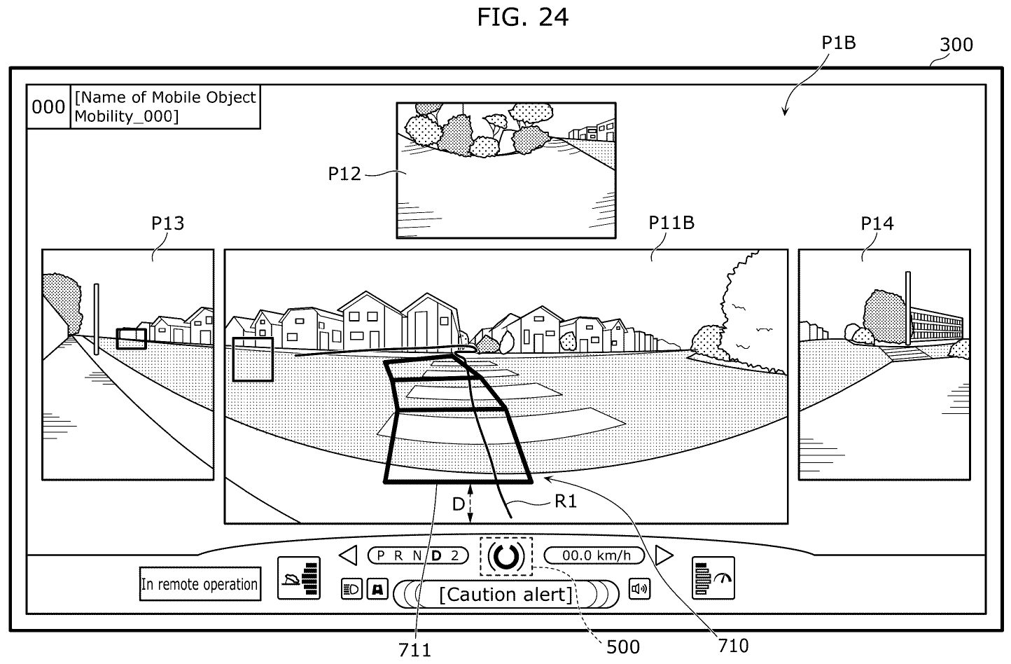

FIG. 24 is a diagram illustrating display image P1B to be displayed on output device 300 according to example 12.

Display image P1B includes, for example, a video (image P11B) capturing a front view of vehicle 20, a video (image P12) capturing a rear view of vehicle 20, a video (image P13) capturing a left side view of vehicle 20, a video (image P14) capturing a right side view of vehicle 20, the steering wheel image such as steering wheel icon 500, etc. Image P11B is an image obtained by superimposing calculated predicted path 710 on image P11 illustrated in FIG. 2 to be displayed. Predicted path 710 is one example of the predicted path image.

Predicted path 710 is calculated by, for example, a method the same as the method of calculating the above-described predicted path 700. In the present example, controller 120 further calculates a display position of predicted path 710. Specifically, controller 120 chooses the display position of start position 711 (the bottom line of the rudder shape representing predicted path 710 in FIG. 24) of predicted path 710. Predicted path 700 illustrated in FIG. 22 is displayed such that predicted path 700 extends upward from the lower edge of image P11A, for example. Meanwhile, controller 120 controls output device 300 to display predicted path 710, not from the lower edge of image P11B, but from a position shifted upward in accordance with the communication delay time and speed of vehicle 20. In the present example, controller 120 calculates this shifted amount, and chooses the display position of predicted path 710 based on the calculated shifted amount. Specifically, controller 120 calculates, in step S932, the above-mentioned shifted amount. Let's say the letter D denotes the shifted amount, D is calculated, for example, as follows.

$$D = t\_delay \times s$$

Note that the expression t_delay indicates a communication delay time and the lowercase letter s indicates a speed of vehicle 20.

In step S940, controller 120 controls output device 300 to display predicted path 710 that is shifted upward from the lower edge of image P11B by only a length corresponding to the calculated D as described above. Since output device 300 displays a video delayed by only the communication delay time, the actual position of vehicle 20 at the present is start position 711 of predicted path 710.

Note that steps S900, S910, S920, S931, S932, and S940 may be executed prior to step S600.

### Conclusion

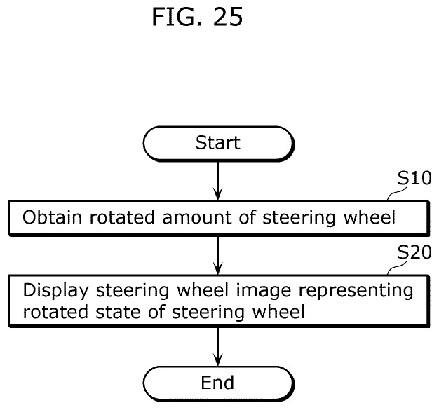

FIG. 25 is a flowchart illustrating an information processing method according to the embodiment. For example, an information processing device includes a processor and memory, and executes an information processing method shown in FIG. 25 using the processor and memory. The information processing device is, for example, management device 100.

First, the information processing device obtains a rotated amount of a steering wheel that controls a movement of a mobile object (S10).

Next, based on the obtained rotated amount, the information processing device controls a display device to display a steering wheel image representing a rotated state of the steering wheel such that the steering wheel image is in a display mode in accordance with the number of rotations made by the steering wheel (S20).

The mobile object is, for example, vehicle 20. The rotated amount is, for example, an operated amount indicated by operation information. The number of rotations is, for example, an integer calculated from the rotated amount (e.g., a numeric value obtained by dropping the fractional portion of a value that is obtained by converting a rotated amount into the number of rotations). The display device is, for example, output device 300. For example, in the process of controlling the display device to display a steering wheel image, the information processing device changes the display mode of the steering wheel image when the number of rotations made by the steering wheel is changed. Moreover, for example, in the process of controlling the display device to display the steering wheel image, the information processing device controls the display device to display the steering wheel image such that the steering wheel image is displayed in different display modes (i) when the steering wheel is rotated at least a predetermined number of times and (ii) when the steering wheel is not rotated at least the predetermined number of times.

According to the above, a user can easily grasp the number of rotations made by the steering wheel. From a functional safety standpoint, an operator is required to immediately stop remote controlling when a system (e.g., a remote control system including terminal 10) used by the operator malfunctions, to decrease the risk of runaway caused by a mobile object such as vehicle 20. In order to implement a countermeasure, there is a need for presenting a rotated amount of the steering wheel on a UI for an operator to understand whether a system used by the operator is correctly recognizing operations of the steering wheel. In view of the above, the steering wheel image is displayed rotated by the same amount as the rotated amount of the steering wheel. With this, operations of the steering wheel can be visualized. Here, just a mere rotation of the steering wheel image (steering wheel icon) representing a rotated state of the steering wheel would not allow an operator to readily understand whether the steering wheel is making at least one rotation from the steering wheel image when, for example, the steering wheel is operated to make at least one rotation. Particularly, when the steering wheel image is displayed to an operator who is remotely controlling a mobile object such as vehicle 20, the operator operates the steering wheel of the mobile object, not using the steering wheel provided by the mobile object, but using, from outside the mobile object, an operation device present at hand. For this reason, in this case, whether the steering wheel is making at least one rotation is particularly difficult to understand from the steering wheel image. In view of the above, the present disclosure controls the display device to display the steering wheel image such that the steering wheel image is displayed in different display modes (i) when the steering wheel is rotated at least a predetermined number of times and (ii) when the steering wheel is not rotated at least the predetermined number of times. For example, when the steering wheel is controlled to make at least one rotation, the color or shape of the steering wheel image is controlled to change. This allows an operator to intuitively grasp how many rotations are made by the steering wheel. From the above, the information processing method according to aspect 1 of the present disclosure can make rotated states of the steering wheel easy to understand.

Moreover, when the steering wheel is operated to make at least one rotation, it is difficult for the operator to understand whether the steering wheel is rotated rightward or leftward just by merely rotating the steering wheel image (steering wheel icon) representing a rotated state of the steering wheel. For example, the color or shape of the steering wheel image is controlled to change differently depending on whether the steering wheel is rotated rightward or whether the steering wheel is rotated leftward. This allows an operator to intuitively grasp how many rotations the steering wheel is making to the right or to the left.

Note that these comprehensive or specific aspects of the present disclosure may be realized by a system, a method, an integrated circuit, a computer program, or a recording medium such as a computer-readable CD-ROM, or by an optional combination of the system, the method, the integrated circuit, the computer program, and the recording medium.

### OTHER EMBODIMENTS

The information processing device, etc. according to one or more aspects of the present disclosure have been hereinbefore described based on the embodiments, but the present disclosure is not limited to these embodiments. The scope of the one or more aspects of the present disclosure may encompass embodiments to which various modifications that may be conceived by those skilled in the art are made and embodiments achieved by combining elements in different embodiments and examples, as long as the resultant embodiments do not depart from the spirit of the present disclosure.

For example, besides vehicle 20, the mobile object may include ships, vessels, aircraft, etc.

Moreover, the display device may be provided in a mobile object, for example. In addition, the information processing device may be provided in the mobile object. Furthermore, the mobile object need not be remotely controlled, but may be operated (driven) by a driver in the mobile object.

Moreover, the present disclosure can realize the steps included in the information processing method as a program to be executed by a processor. Furthermore, the present disclosure can be realized as a non-transitory computer-readable recording medium on which the above-described program is recorded, such as a CD-ROM.

In addition, when, for example, the present disclosure is realized by a program (software), each step is executed by executing the program using hardware resources such as the CPU, memory, and an input/output circuit of a computer. Specifically, each step is executed by the CPU (i) obtaining data from the memory or the input-output circuit and calculating the data and (ii) outputting a calculation result to the memory or the input/output circuit.

Note that, in the above-described embodiments, each of elements included in terminal 10 may be configured in the form of an exclusive hardware product or by executing a software program suitable for the element. Each element may be realized as a result of a program execution unit, such as a CPU, processor or the like, loading and executing a software program stored in a recording medium such as a hard disk or a semiconductor memory.

Some or all of functions of management device 100 according to the above-described embodiment are typically realized as a large-scale integration (LSI) circuit, which is an integrated circuit. These circuits each may be individually realized as a single chip or may be realized as a single chip including some or all of the circuits. Moreover, circuit integration is not limited to an LSI circuit; circuit integration may be realized by a dedicated circuit or generic processor. A field programmable gate array (FPGA) that can be programmed after the manufacturing of the LSI circuit, or a reconfigurable processor that allows the reconfiguration of the connection and setting of a circuit cell inside the LSI circuit may be used.

The present disclosure further encompasses various variations obtained by making, to the embodiments of the present disclosure, modifications within the scope conceivable by those skilled in the art, as long as the variations do not depart from the spirit of the present disclosure.

### INDUSTRIAL APPLICABILITY

The present disclosure is applicable to systems that assist operators in remotely controlling mobile objects.

1. An information processing method comprising:
obtaining a rotated amount of a steering wheel that controls a movement of a mobile object; and
based on the rotated amount obtained, controlling a display device to display a steering wheel image in a display mode in accordance with a total number of rotations made by the steering wheel, the steering wheel image representing a rotated state of the steering wheel.

2. The information processing method according to claim 1, wherein
in the controlling, the display device is controlled to display the steering wheel image in a display mode in accordance with a direction in which the steering wheel is rotated.

3. The information processing method according to claim 1, wherein
in the controlling, the display device is controlled to display the steering wheel image in different display modes when the steering wheel is rotated and when the steering wheel is not rotated.

4. The information processing method according to claim 1, wherein
the steering wheel is an operation device operated by an operator and connected to an information processing device that communicates with the mobile object, and
in the controlling, the display device is controlled to display the steering wheel image in different display modes (i) when the operation device and the information processing device are not connected or when the information processing device and the mobile object are incapable of communicating with each other and (ii) when the operation device and the information processing device are connected and the information processing device and the mobile object are capable of communicating with each other.

5. The information processing method according to claim 1, wherein
in the controlling, the display device is controlled to display the steering wheel image that includes a numeric value indicating the rotated amount.

6. The information processing method according to claim 1, wherein
in the controlling, the display device is controlled to display the steering wheel image in different display modes when the rotated amount is a limit value and when the rotated amount is not the limit value.

7. The information processing method according to claim 1, wherein
in the controlling, the display device is controlled to display the steering wheel image including a steering angle image representing a steering angle of the mobile object.

8. The information processing method according to claim 1, further comprising:
estimating a travel route of the mobile object based on a steering angle of the mobile object, wherein
in the controlling, the display device is further controlled to display a predicted path image representing the travel route estimated.

9. A non-transitory computer-readable recording medium for use in a computer, the recording medium having recorded thereon a computer program for causing the computer to execute the information processing method according to claim 1.

10. An information processing device comprising:
an obtainer that obtains a rotated amount of a steering wheel that controls a movement of a mobile object; and
a controller that controls, based on the rotated amount obtained, a display device to display a steering wheel image in a display mode in accordance with a total number of rotations made by the steering wheel, the steering wheel image representing a rotated state of the steering wheel.
